(19) United States
(12) Patent Application Publication
(10) Pub. No.: US 2016/0195246 A1
(43) Pub. Date: Jul. 7, 2016

(54) MODULAR UNIT FOR A TRANSPORT DEVICE

(71) Applicants: Abraham Carattini, Corona, CA (US); Rodolfo Gastelum, San Pedro, CA (US); Matthew Lazich, Austin, CA (US)

(72) Inventors: Abraham Carattini, Corona, CA (US); Rodolfo Gastelum, San Pedro, CA (US); Matthew Lazich, Austin, CA (US)

(21) Appl. No.: 14/989,034

(22) Filed: Jan. 6, 2016

Related U.S. Application Data
(60) Provisional application No. 62/100,215, filed on Jan. 6, 2015.

(51) Int. Cl. F21V 17/00; F21V 17/10; F21S 8/10; F21V 23/00; F21V 33/00; A63C 17/26; F21V 17/08

(52) U.S. Cl. CPC F21V 17/002; A63C 17/26; F21V 17/104; F21V 17/08; F21V 23/003; F21V 33/0056; F21S 48/30; F21W 2101/02

(57) ABSTRACT

A replaceable quick release modular unit for a transport device. The transport device comprising an anchor plate fastened to the transport device. A housing having a fastening mechanism adapted to releasably connect to the anchor plate is provided. The housing further includes an illumination source, an audio source and an electronic control unit (ECU) electrically connected to control the illumination source and the audio source. A wireless communication transceiver may be provided and adapted to send and receive wireless signals from a remote device that communicates with the ECU to control the operation of the illumination and audio sources.

### CROSS REFERENCE TO RELATED APPLICATIONS

This application is a Non-Provisional application and claims priority to U.S. Provisional Application Ser. No. 62/100,215 filed Jan. 6, 2015, the contents of all of which are hereby incorporated by reference herein in their entirety into this disclosure.

### BACKGROUND

1. Field

This invention relates to a safety system for a recreational vehicle, and more particularly, to an illumination and audio system for a transport device.

2. Description of the Related Art

Previously, ensuring the safety of a sport board rider engaging in an active sporting activity with a transport device, such as a skateboarder, a snowboarder, a skier, a scooter and the like has been quite challenging, especially at night as there are numerous dangers encountered by an uneven road or a vehicle being unable to see the rider of the transport device. For example, skateboarding is a recreational active sport which involves the user riding and performing tricks using a skateboard. Skateboarding can also be considered an art form, a job, or a method of transportation and has been shaped and influenced by many skateboarders throughout the years.

As its popularity and skateboard riders grew, so did the number of accidents incurred by skateboarders. Particularly, at night, a skateboarder becomes practically invisible to motorists and others. Unlike bicycles, skateboards are not outfitted with lights and reflective gear, making them much harder to see at night. Likewise, for a skateboarder, the surface road being traversed becomes extremely difficult to inspect while riding thereon thereby heightening the dangers encountered by a skateboarding riding on a dangerous uneven surface

There is still a longstanding need to provide a suitable illumination source on a skateboard to overcome these inherent dangers. In accordance with this invention, an exemplary safety system is proposed for providing illumination and audio to a skateboard according to this subject disclosure.

### SUMMARY

A replaceable quick release modular unit for a transport device. The transport device comprising an anchor plate fastened to the transport device. A housing having a fastening mechanism adapted to releasably connect to the anchor plate is provided. The housing further includes an illumination source, an audio source and an electronic control unit (ECU) electrically connected to control the illumination source and the audio source. A wireless communication transceiver may be provided and adapted to send and receive wireless signals from a remote device that communicates with the ECU to control the operation of the illumination and audio sources.

### BRIEF DESCRIPTION OF THE DRAWINGS

Various exemplary embodiments of this invention will be described in detail, wherein like reference numerals refer to identical or similar components or steps, with reference to the following figures, wherein:

FIGS. 1-3 illustrate various exemplary perspective views of an embodiment of a skateboard including an illumination and audio system accordance to this subject disclosure.

FIG. 4 shows a top view of the skateboard having the illumination and audio system.

FIGS. 5-6 depict bottom views of the skateboard having the illumination and audio system.

FIG. 7-8 illustrates side views of the illumination and audio system on the skateboard.

FIG. 9 shows a partial view of the front truck and ornamental design thereof.

FIG. 10 depicts a side perspective view of the front truck and ornamental design thereof including a replaceable self contained modular unit.

FIG. 11 depicts a side perspective view of the control circuit and ports into the illumination and audio system.

FIG. 12 depicts a power charger adapted to recharge the rechargeable batteries in the illumination and audio system.

FIG. 13 depicts a side view of the control circuit and ports into the illumination and audio system including replaceable self contained modular units in front and to the rear of the truck.

FIG. 14 shows rear and front view of the skateboard integrating rear and front illumination and audio systems on a skateboard.

FIG. 15 illustrates a side view of the skateboard integrating rear and front illumination and audio systems on a skateboard.

FIG. 16 depicts a front view of the skateboard integrating rear and front illumination and audio systems on a front truck of the skateboard.

FIG. 17 shows a partial bottom view of the skateboard integrating rear and front illumination and audio systems on a front truck of the skateboard.

FIG. 18 illustrates a disassembled exemplary interchangeable front and rear retractable modular illumination and audio systems for use with a skateboard.

FIG. 19 shows a rear view assembled exemplary interchangeable front and rear retractable modular illumination and audio systems for use with a skateboard.

FIG. 20 depicts a partial bottom view of an audio module attached to the deck of the skateboard.

FIGS. 21-23 illustrate various views of a self contained truck assembly integrated in the truck of the skateboard.

FIG. 24 shows the illumination module embodied as a clip-on module disposed at the nose of the skateboard.

FIG. 25 depicts illustrates an integrated self contained modular unit having an illumination portion provided thereon.

FIGS. 26-28 provide various other items into which the self contained modular unit can be used with.

FIG. 29 illustrates various possible wrist attachments for a wireless device capable of controlling the self contained modular unit on the skateboard.

FIG. 30 shows a top perspective of an illumination system connected to the self contained modular unit on the skateboard.

FIG. 31 depicts a lower perspective of the illumination system connected to the self contained modular unit on the skateboard.

FIG. 32 illustrates an exploded view of the illumination system connected to the ECU in the skateboard.

FIG. 33 shows a cross section view of the inlaid illumination system in the deck of the skateboard.

FIG. 34 shows an enlarged cross section view of the inlaid illumination system in the deck of the skateboard.

### DETAILED DESCRIPTION OF EXEMPLARY EMBODIMENTS

Particular embodiments of the present invention will now be described in greater detail with reference to the figures.

Although shown in a particular embodiment below, it is contemplated that the replaceable self-contained modular unit 70 may be adapted for use with various types of transport device, such as one being used on land, in the air and/or in water.

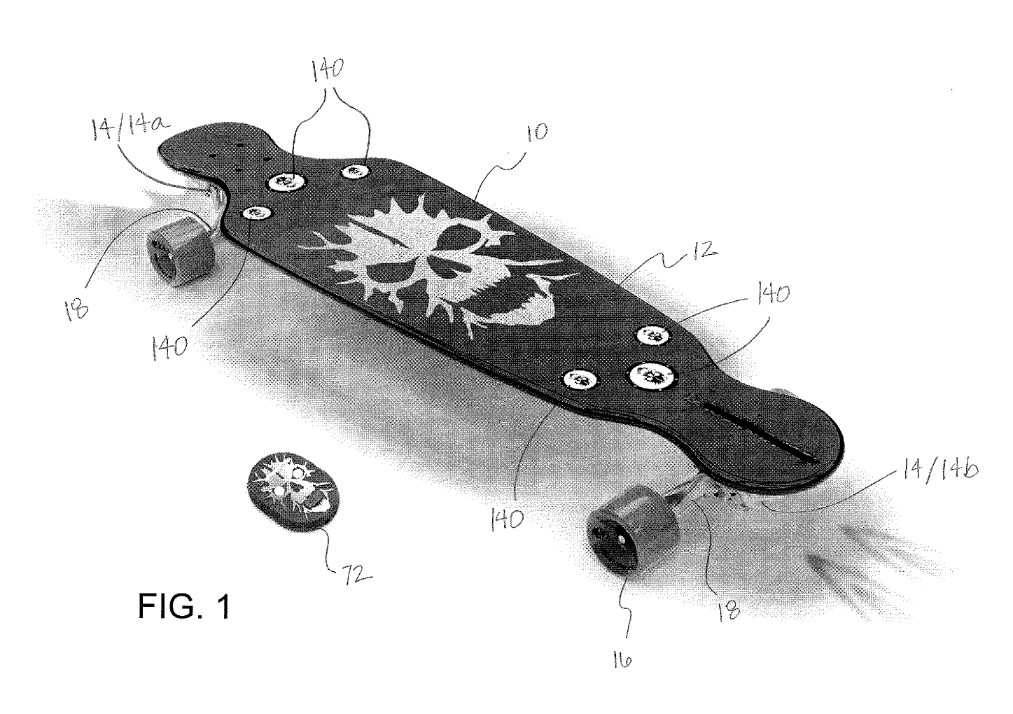

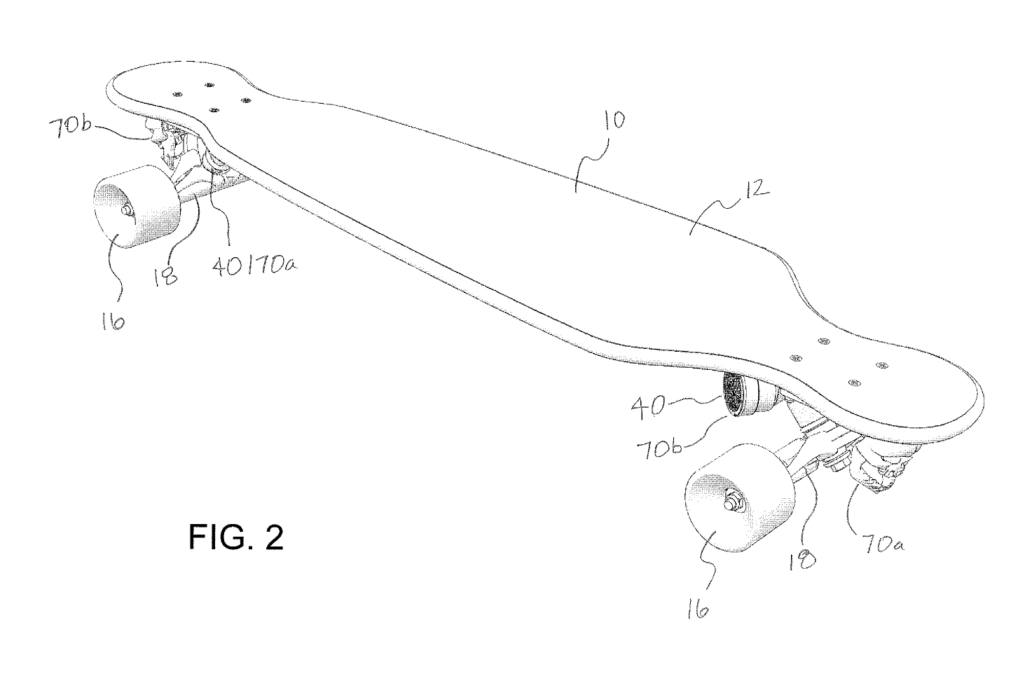

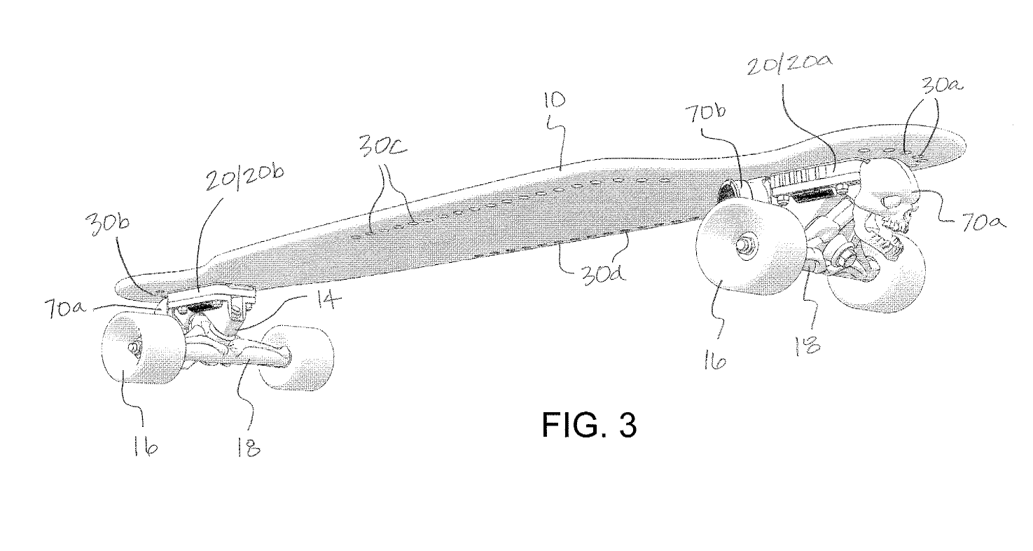

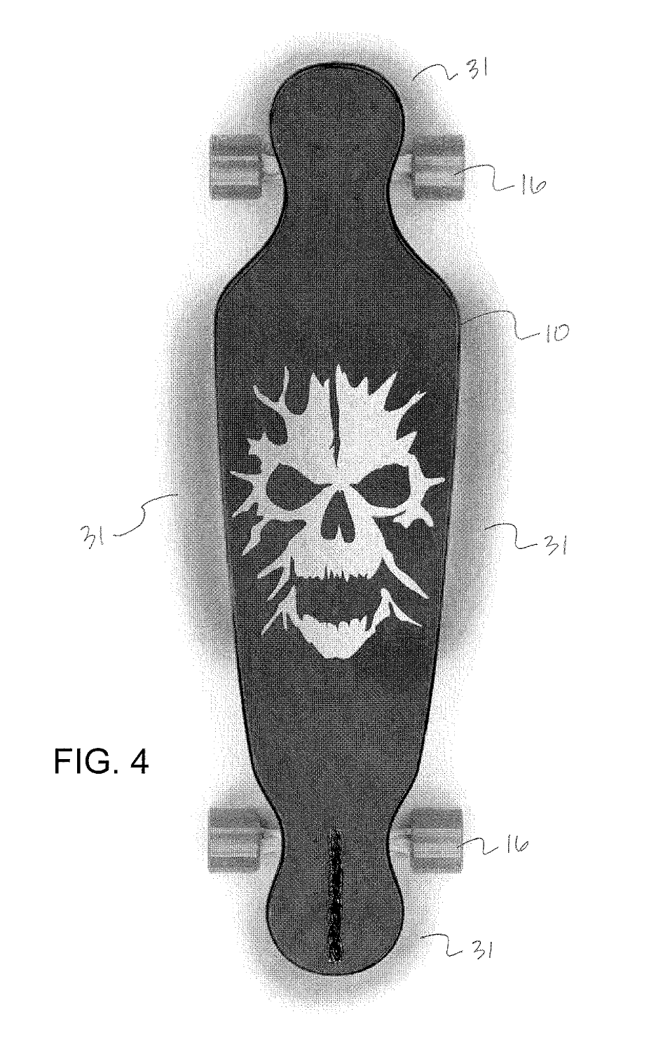

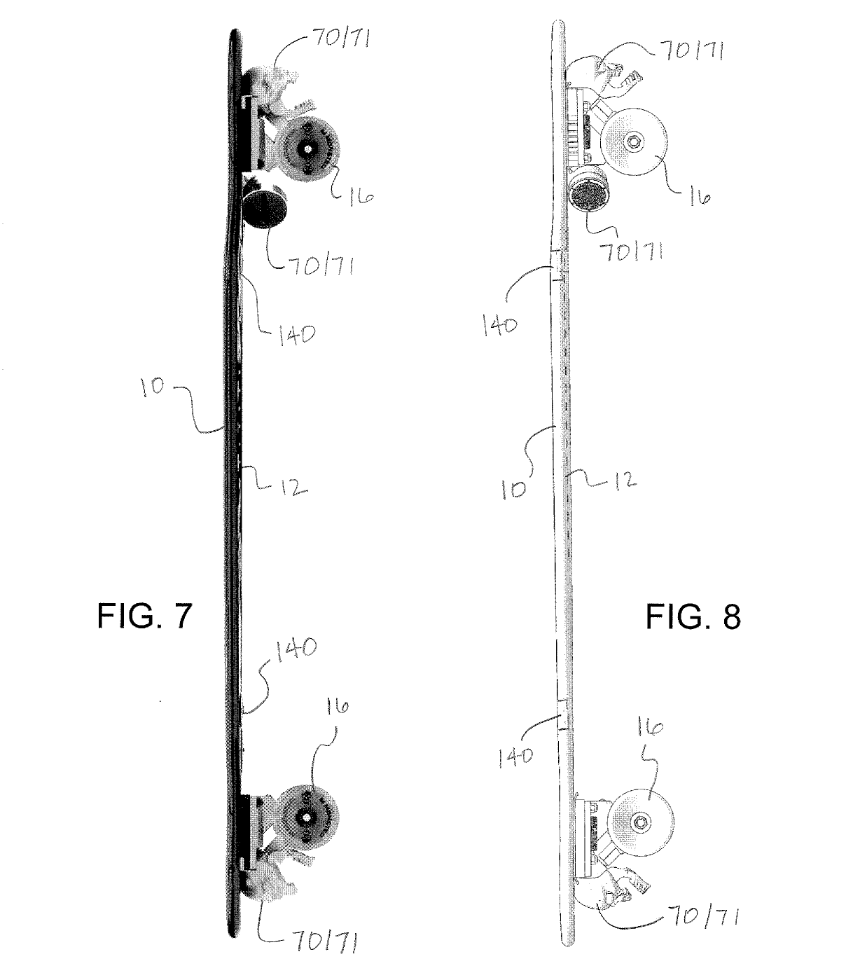

FIGS. 1-8 depict various views of a replaceable self-contained modular unit 70 for use with one example of a transport device. It is to be understood that the modular unit 70 may be adapted for use on a variety of different land, air and aqueous based transport devices, such as a skateboard, a scooter, a bicycle, motorcycle, an all terrain vehicle, a hover board, a snow board, skis, watercraft, wakeboard, skim board, surfboard, boogie board and/or may be attached to the decks, bindings and/or any type of surface on any number of commercially available transport devices. Although various other transport devices are possible, according to this subject disclosure, the transport device may be, as illustrated a skateboard 10 including replaceable self-contained modular unit 70.

The replaceable self-contained modular unit 70 on the transport device or skateboard 10 may be adapted to produce a source of light and a source of sound. The skateboard 10 has a board deck 12, a pair of trucks 14, that is, a front truck 14a and a rear truck 14b. A pair of wheels 16 is provided on opposite sides of an axle 18 supported and secured by the trucks 14. A front pair of wheels 16a and front axle 18a is attached to the front truck 14a, and a rear pair of wheels 16b and a rear axle 18b is attached to the rear truck 14b. Risers 20, a front riser 20a and a rear riser 20b, are disposed between the trucks 14 and the board deck 12.

At least one replaceable self-contained modular unit 70 is adapted for use in combination with the skateboard 10. An electronic control unit (ECU) 50 may be integrated with the replaceable self-contained modular unit 70 and the skateboard 10 to produce an illuminated light source 30 and an audio source 40. The ECU 50 is disposed within an electronic control circuit 51 and adapted to control the operation of the illuminated light source 30 and an audio source 40. The illumination source 30 may come in the form of various lights and the audio source 40 may be provided in the form of a speaker that emanates various audible tones.

The skateboard 10 may also include the use of a remote control device 72 that communicates wirelessly with the ECU 50. The remote control device 72 may be adapted to send instructions to control the various components in the electronic control circuit 51 disposed within the replaceable self-contained modular unit 70 attached to the skateboard 10. The remote control device 72 may be embodied as a variety of different short range transmission devices, such as a mobile phone, a portable digital assistant, and/or other wireless device capable of sending and receiving instructions to a wireless transceiver electronically connected to the ECU 50 disposed in the control circuit 51.

FIGS. 1 and 4-6 illustrates the skateboard 10 including various illuminating lights 30 disposed throughout the skateboard 10 that produce various illuminating light patterns 31. The lights 30 may be selected from a variety of different sources, including but not limited to light emitting diodes (LED's) and/or other illuminating light projecting sources and the like. The lights 30 may be embodied as replaceable self contained modules having integrated batteries, as embedded lights connected together and integrated within the skateboard 10.

The lights 30 may be embedded within various recesses 13a or channels 13b disposed within the body of the deck 12 of the board. The recesses 13a may be provided on an upper surface 12a or a lower surface 12b of the deck 12 of the board. The recesses 13a may extend completely through the deck 12 of the board or be routed in the deck 12 as a blind face bore into which the lights 30 may be disposed. Likewise, the recesses 13a may be provided along the outer edge surface 12c or periphery of the deck 12 of the board.

The deck 12 of the skateboard 10 may be constructed in a variety of different ways, including but not limited to a construction including a double press board. Disposed between therein, the control circuit 51 may be a flex circuit board with LED injected or stamped between the boards before the double press board is pressed together and fastened to each other forming the deck 12 of the skateboard 10.

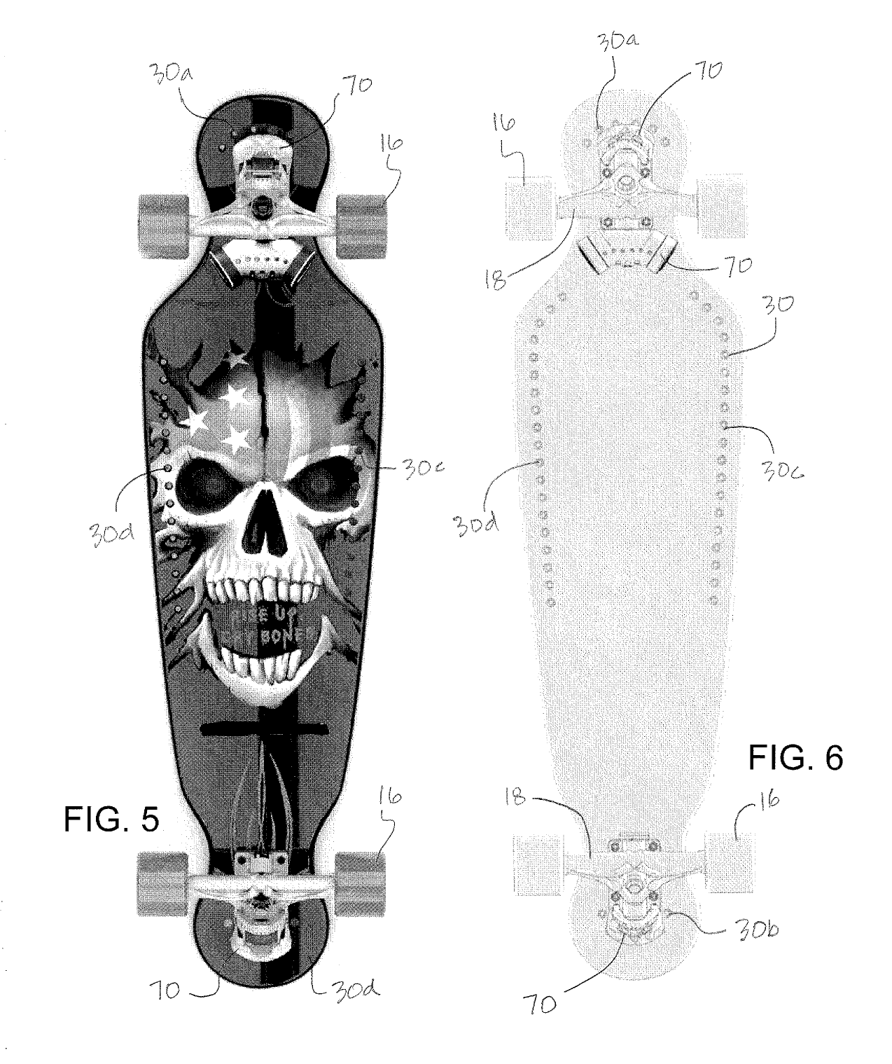

FIGS. 1 and 6 show at least one exemplary illumination pattern emanating from the skateboard 10. It is to be understood that various patterns and routines that control the various lights 30 may be selected according to this subject disclosure. As shown in FIGS. 5-6, the lights 30 are arranged as a set of front lights 30a, a set of rear lights 30b, a set of right side lights 30c and a set of left side lights 30d. The various sets of lights 30a, 30b, 30c, 30d as shown are disposed in the lower side 12b of the deck 12 of the board such that each of the recesses 13 are interconnected by a channel 13b extending from the ECU 50. Various other lights may be disposed on or within the skateboard 10 and will be described later with respect to a replaceable self-contained modular unit 70.

The illuminating lights 30 may be provided as a connected strip of lights 32. The strip of lights 32 may be fastened to the deck 12 in various ways, such as being disposed in a recess 13a, channel 13b or groove. The strip of lights 32 may be snap-locked into the channel 13b or groove or adhered to any surface of the deck 12 of the board. The fastening or adhesive mechanism used to adhere the strip of lights 32 to the deck 12 may be selected from at least one or more of an adhesive, VBH tape, glue, screws, a hook and loop fastener and/or any other suitable adhesive or fastener.

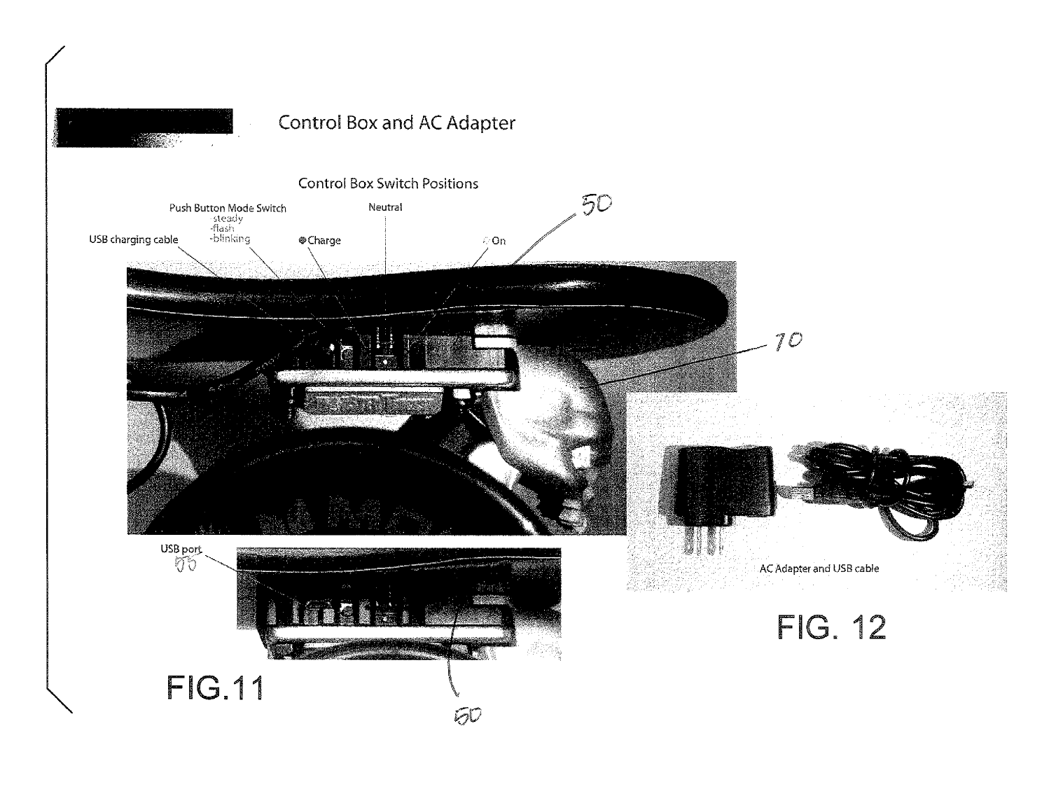

FIGS. 11 and 22-23 show an electronic control unit (ECU) 50 controlling an electronic control circuit 51 provided in the skateboard 10. The electronic control circuit 51 may include a battery 52, lights 30, an audio module 40 including an amplifier and a speaker, a wireless transceiver 54 to send and receive data information, storage memory 56 to store various predefined routines, and an on/off switching element 58 to activate and deactivate the electronic control circuit 51. Each of the various elements in the electronic control circuit 51 is electronically connected within the skateboard 10 and/or may be provided in at least one of the replaceable self-contained modular units 70.

In one embodiment, the elements of the electronic control circuit 51 are distributed and electronically integrated throughout the skateboard 10. In another construction, the various elements of the circuit 51 may be self contained in a self-contained truck assembly 60 or self contained in a replaceable self-contained modular unit 70 as will be described in more detail later. Various short-range wireless interconnection technologies can be included in the electronic control circuitry 51, including but not limited to Bluetooth, GPS, near field communication, RF, a motion sensor such as an accelerometer, a speedometer and the like.

Control for the lights 30 and/or other features may be adapted to interact with the short-range wireless interconnection technology, such as a Bluetooth receiver unit. The Bluetooth receiver unit may be capable of communicating with remote speakers, other controllers, a cell phone, a mobile device, and various types of music devices, earphones, lasers, horns, and/or any other suitable device capable of transceiving Bluetooth signaling or the like.

The illuminating lights 30 may be connected in a distributed electronic control circuit 51 integrated into the deck 12 or constructed as a self-contained replaceable modular unit 70 that includes its own power and control unit to activate and control the illuminating/flashing transmission routine patterns of the lights 30 from various selectable routines controlled by the ECU 50 and stored in the control circuit 51. Likewise, an audio transmission routine pattern of the audio source 40 may also be controlled by the ECU 50. In response to various parameters occurring with the movement, position and/or environment around the skateboard 10, the audio source 40 can be activated and controlled to transmit various audio transmission routine patterns from various selectable routines controlled by the ECU 50.

The ECU 50 in the control circuit 51 controls the illumination of the lights 30 in response to various components, such as for example, but not limited to, motion sensing element. The motion sensing element or electronic motion detector may employ optical, microwave and/or acoustic sensors. One such sensor, may be the use of an electronically connected accelerometer 57. The accelerometer 57 may be adapted to sense the movement and direction of the skateboard 10. In response thereto, the ECU 50 can select from various commands that cause the lights 30 to illuminate based on a selected routine scheme stored in memory 56 within the control circuit 51.

For example, as the skateboarder moves forward and begins to lean the skateboard 10 into a turn to the right, those lights 30 on the front 30a and right side 30b of the deck 12 in the direction in which the skateboard 10 is moving may be activated to turn on or illuminate with a higher intensity so that the skateboarders view path in which he is moving will be enhanced thereby increasing the safety to the rider in a dark environment. Likewise, the lights 30b facing rearward and/or disposed at the rear of the deck 12 may blink or increase in intensity to alert a person behind the skateboarder of the direction in which the skateboard 10 is turning, much like a brake light or blinker on a vehicle. Although one example is provided, it is to be understood that various lights routines can be implemented and selected in response to the directional movement of the skateboard 10.

That is, various selected patterns for illuminating the lights 30 may be rendered based on the motion of the skateboard 10. A selection of light illumination patterns may be stored in a memory and compared to the motion of the skateboard 10. Based on the measured movement, such as for example by an accelerometer, a light illumination pattern is selected and rendered by the control circuit 51. Likewise, the motion sensor may also be used to cause the ECU 50 to send instructions to the audio source 40 to perform specific audio based routines as will be discussed.

Alternatively, motion sensing devices in a mobile device can be used to wirelessly communicate with the ECU 50 in the skateboard 10 to perform various features and/or functionality. For example, if the user or skateboarder carries his mobile phone in his pocket as he rides atop of the skateboard 10 movement sensed by the accelerometer in the mobile device can send specific wireless instructions to the ECU 50 in the skateboard 10 to perform various functions, such as to turn on selected lights 30 mounted to the skateboard 10. In this way, the mobile device carried on the user interacts directly with the ECU 50 on the skateboard 10 without direct commands being sent from the skateboarder who rides atop the skateboard 10.

The illuminated lights 30 may be embodied as flexible elements, either self-contained or distributed and electronically connected to the control circuit 51. The flexible elements would be beneficial in bending and making turns along the curved surface of the deck 12 of the board, or inset within channel 13b or grooves in the deck 12.

The power source or battery 52 powering the illuminating lights 30 may be a rechargeable battery which may be externally recharged from an external charging source as shown in FIG. 12, such as a wall power plug, a USB plug, a portable power source and/or any other suitable source for recharging the batteries. The power source 52 may be integrated within the housing of the illuminating light 30 source, or may be disposed as a remote power source.

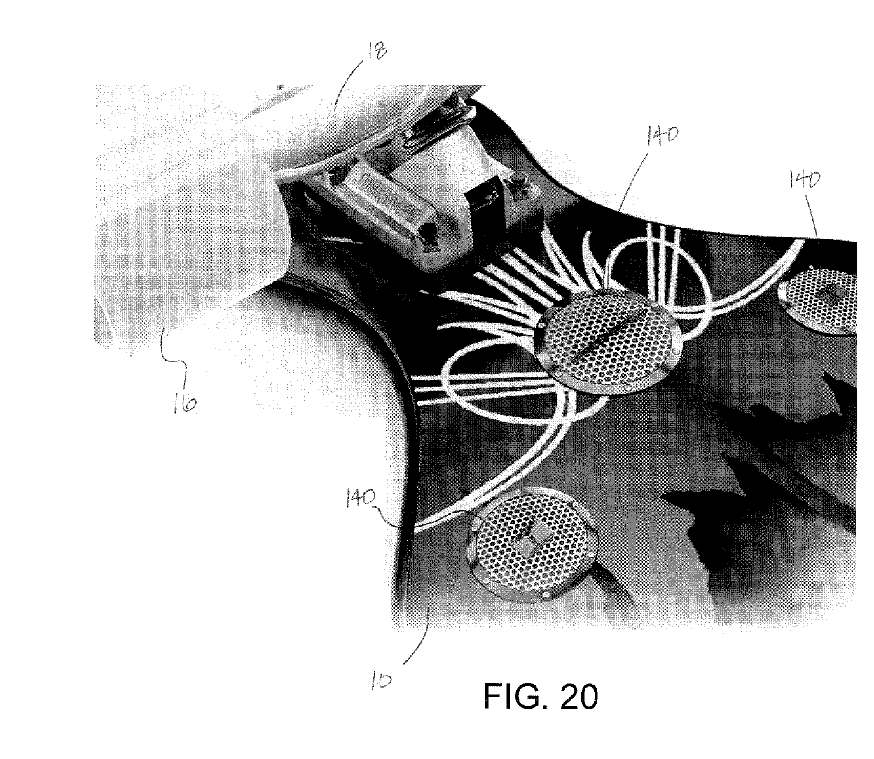

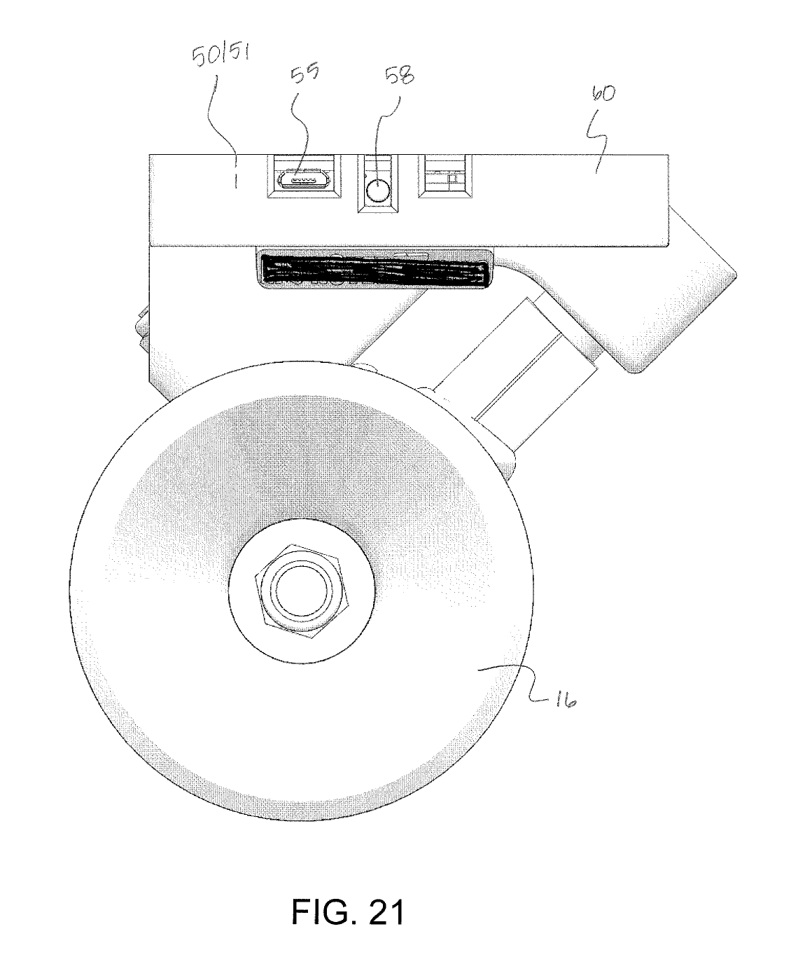

FIG. 20 shows various audio modules 140 may also be connected within the deck 12 of the skateboard 10 and electronically connected in the control circuit 51 and controlled by the ECU 50. A flexible conductor element, like a wire or other conductor material, may be provided in the deck 12 and extending to the audio module 140 from the ECU 50. Various other audio components in the control circuit 51 may be electrically connected to the audio module 140 and/or other components in the control circuit 51.

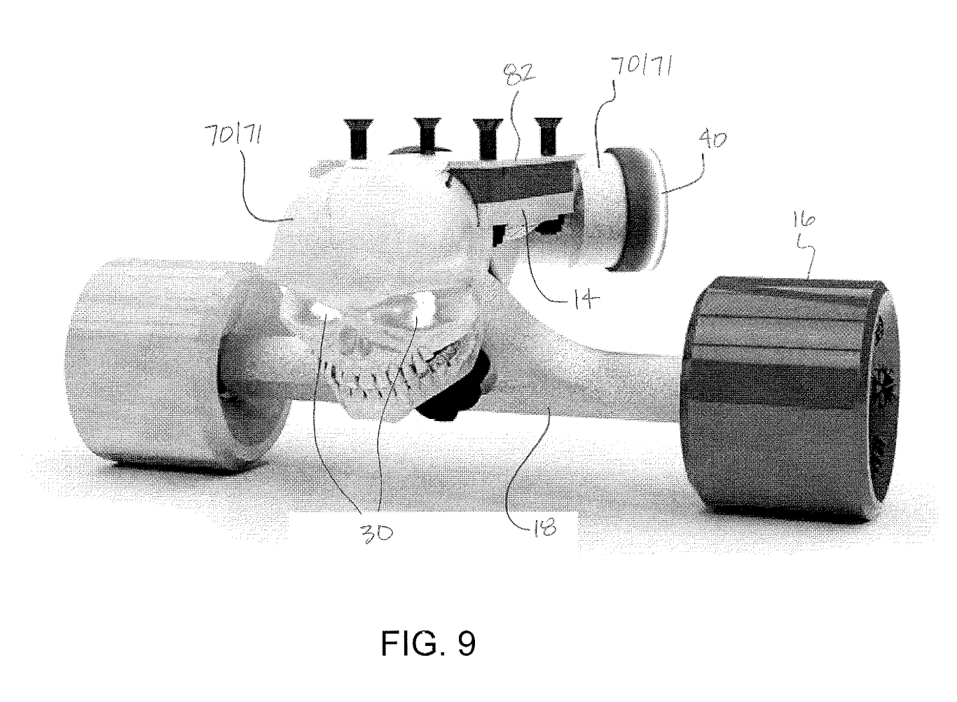

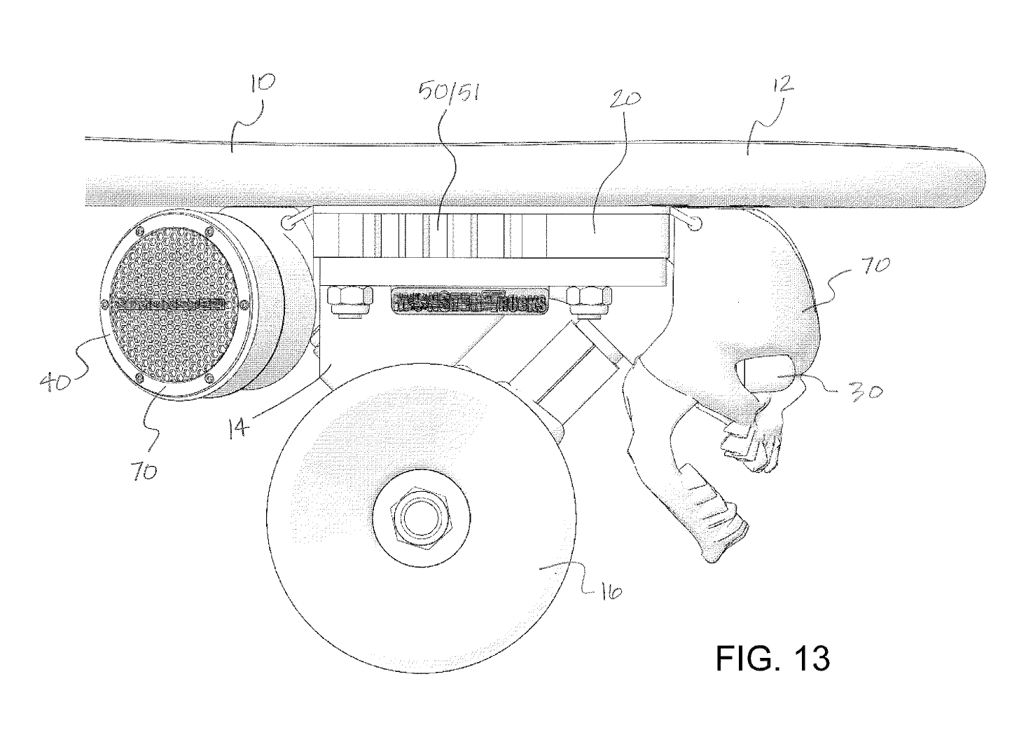

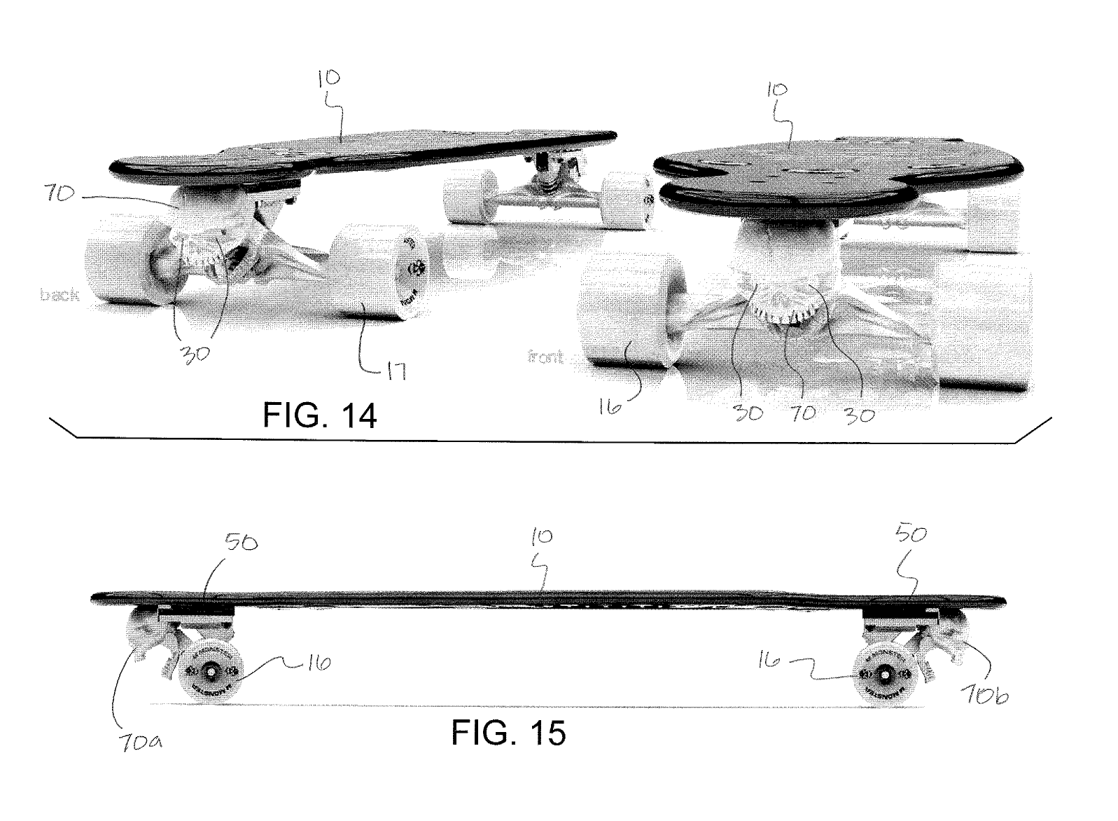

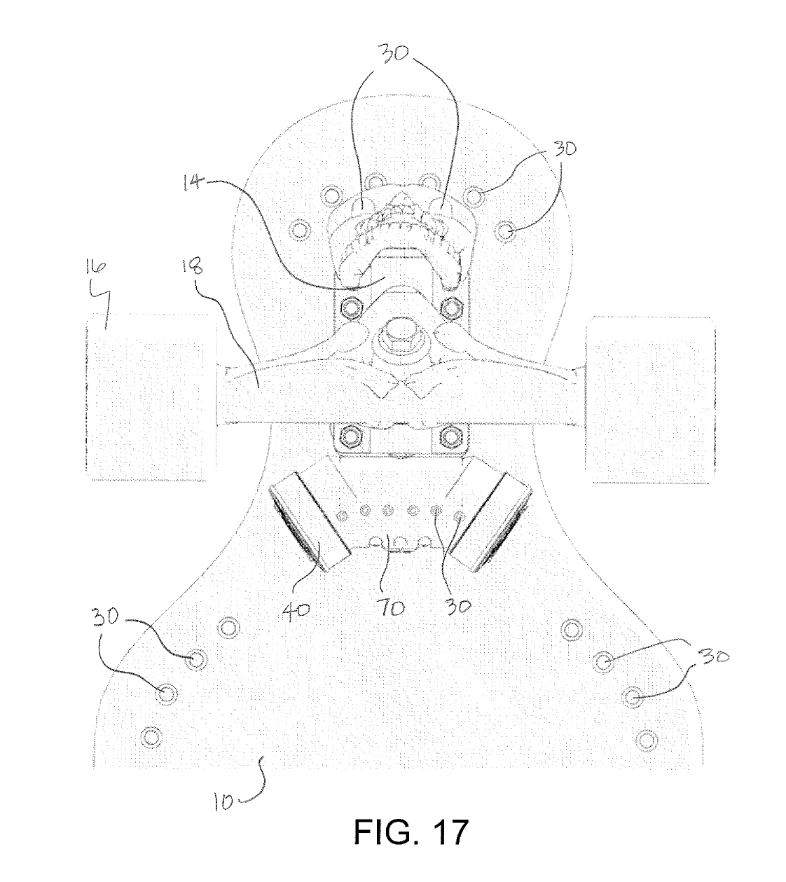

FIGS. 9-10 and 13-19 show another exemplary embodiment in which a replaceable self-contained modular unit 70 is provided that can be quickly disconnected and easily interchanged and replaced out with another different self-contained modular unit 70. As defined, the replaceable self-contained modular unit 70 is replaceable and modular and can be easily attached and disconnected or released from the skateboard 10 very quickly. Very quickly would mean, such as in a matter of seconds, such as 1 to 2 seconds, such as where only a few motions would be needed to connect or disconnect the replaceable self-contained modular unit 70 from the skateboard 10. This is very different from the use of a threaded screw fastener which would require substantial tools, time, energy and motion to rotate the threaded screw fastener a number of times to thread and unthread numerous threads on a mechanical threaded screw fastener in order to permanently attach or detach one object from another. The connection and disconnection of the replaceable self-contained modular unit 70 would not amount to a semi-permanent or permanent attachment to the skateboard 10 as this would be contrary to the quick release nature of this subject disclosure.

The replaceable self-contained modular unit 70 includes a self contained housing 71 that can be easily connected and disconnected from the skateboard 10 in a quick manner. Various features within the control circuit 51 may be selectively contained within its self contained housing 71 such as, an illumination source 30, an audio source 40, a wireless transceiver 54, a motion sensor 57 and an ECU 50 having an electronic control circuit 51, all electronically connected to the various features and/or electronic elements.

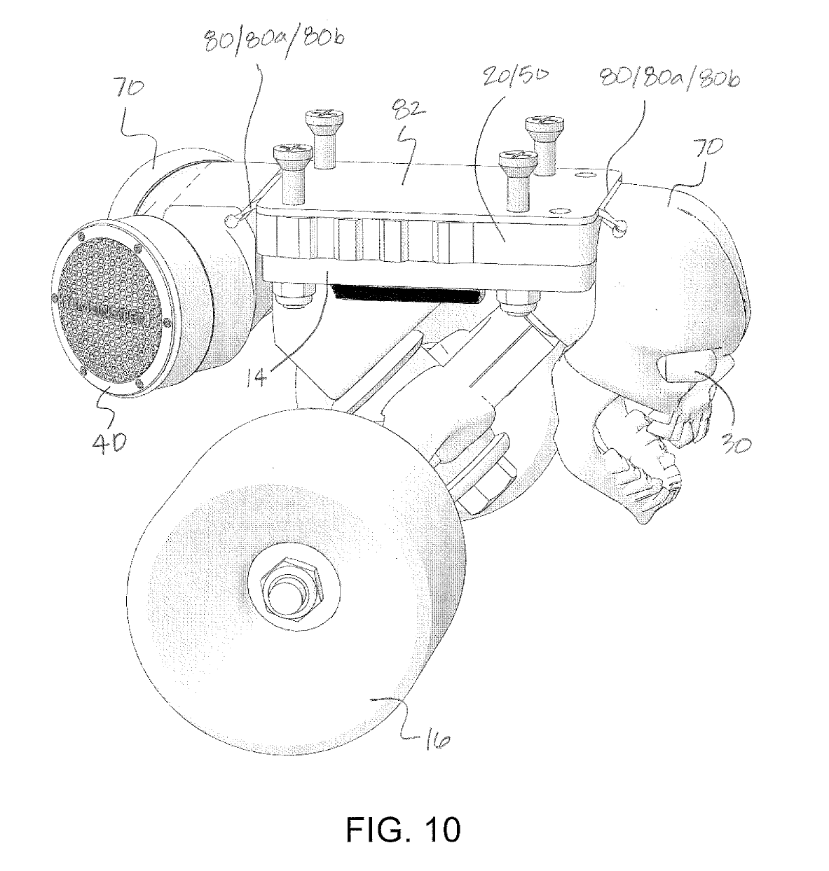

FIGS. 9-10 illustrate examples of two different types of replaceable self-contained modular units 70. The first replaceable self-contained modular unit 70a being an illumination unit 30 attached at a first end to an anchor unit 82. The second replaceable self-contained modular unit 70b is an audio module 40 attached to a second end of the anchor unit 82.

Alternatively, the replaceable self-contained modular unit 70 may house, in combination, an illumination 30 and an audio 40 source, a wireless transceiver 54, a motion sensor 57 and an electronic control circuit 51 all electronically connected and integrated into the replaceable self-contained modular unit 70.

One of the advantages of the replaceable self-contained modular unit 70 is that the user can quickly connect; disconnect or interchange the replaceable self-contained modular unit 70 to a skateboard 10 in a quick and easy manner without needing to use tools to remove cumbersome threaded fasteners to disassemble the replaceable self-contained modular unit 70. Various other features and/or components may be integrated into the circuit 51 provided within the replaceable self-contained modular unit 70, such as for example a horn, a laser, and/or any other suitable feature according to this subject disclosure.

FIGS. 10 and 18-19 shows an exemplary fastening mechanism 80 adapted to secure the replaceable self-contained modular unit 70 to the skateboard 10. The fastening mechanism 80 may be constructed in a variety of different ways. For example, the fastening mechanism 80 may be a sliding and locking mechanism that releasably fastens the replaceable self-contained modular unit 70 to the skateboard 10 as shown herein.

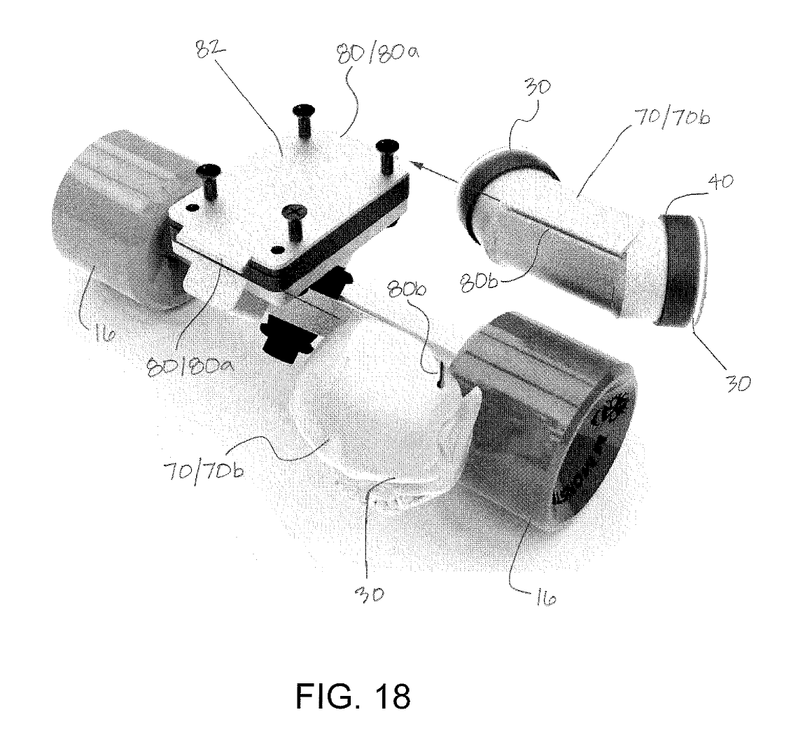

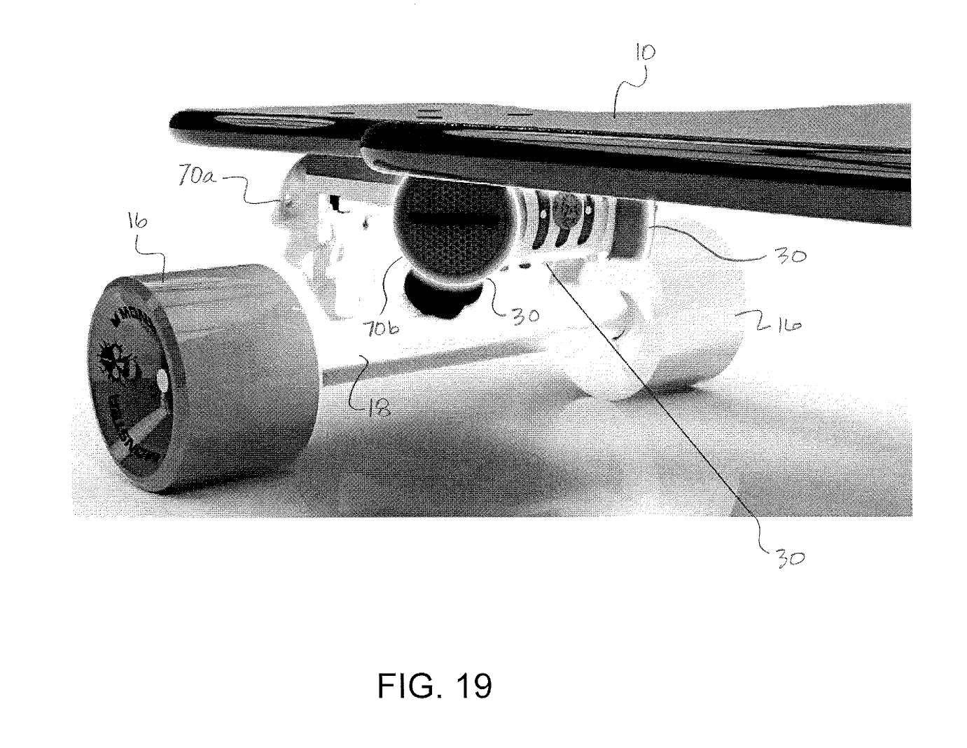

As shown in FIGS. 18-19, a mating connection may be provided at the fastening connection 80 between the skateboard 10 and the replaceable self-contained modular unit 70. That is, an anchor plate or unit 82 may be provided between the trucks 14 and the deck 12. The replaceable self-contained modular unit 70 may include a female receiving channel or groove 80b that slides onto a male projection 80a portion extending from the anchor unit 82. In a secured position, the male projection 80a is locked into the female receiving channel or groove 80b provided in the replaceable self-contained modular unit 70 by a snap lock construction.

As shown, two interchangeable replaceable self-contained modular units 70; 70a and 70b may be attached to the plate 82. The first replaceable self-contained modular unit 70a having an illumination source 30 may be constructed as a stylized character housing, such as the skull member housing shown. The first replaceable self-contained modular unit 70a may be attached to the plate 82 in a forward facing position so that the lights illuminating through the eyes of the skull member housing face forward lighting the path for the skateboard 10 user. When the first replaceable self-contained modular unit 70a is connected to the plate 82, an electrode contact may be made between the electronic control circuit 51 and the illumination source 30 in the first replaceable self-contained modular unit 70a to provide current to the lights 30 in the eyes of the skull member housing.

Although shown as a skull, the replaceable self-contained modular unit 70a including the illumination source 30 can take a variety of different sizes and/or shapes, including but not limited to sharks, zombies, cobra, bats, dragons and/or any other desired shape including various features that may be illuminated, such as the eyes or the like according to this subject disclosure.

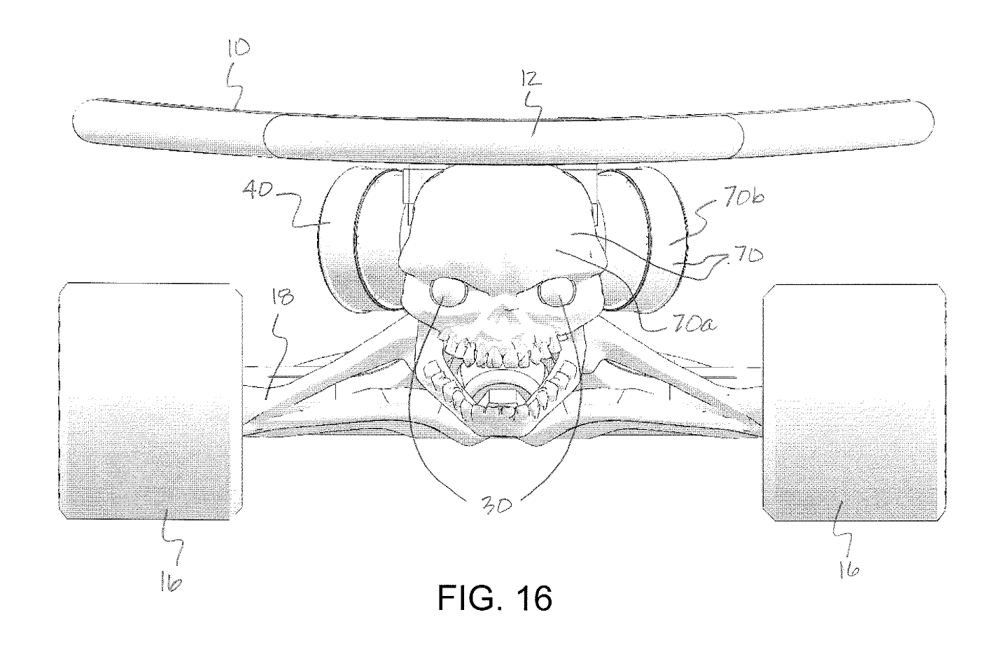

As shown in FIG. 16, the arms 75 of the skull can be constructed to clamp onto the axle 18 of the skateboard 10 by a snap fit construction. This attachment will enhance the secure fastening of the skull shaped self contained modular unit 70a including the illumination source 30 to the front of the truck 14 and front axle 18a. Likewise, the first replaceable self-contained modular unit 70a may also include an audio source 40 embedded therein to provide music from the self contained modular unit 70a. The music may be streamed from a remote streaming controller 72 such as a mobile device.

A second replaceable self-contained modular unit 70b including an audio source 40 may be attached to the plate 82 on an opposite side in a rearward facing position so that the audio source 40 may be attached in rearward facing direction. The second replaceable self-contained modular unit 70b may also include an illumination source 30 integrated therein. Although shown containing a particular shape, it is to be understood that the replaceable self-contained modular units 70a, 70b may take various sizes and/or shapes and the illumination source 30 and the audio source 40 contained therein may illuminate light 30 and audio. The lights 30 and/or audio 40 may be positioned in any direction within the replaceable self-contained modular unit 70b. Similarly, first and/or second replaceable self-contained modular units 70a, 70b may also be attached to a rear anchor unit 82b adjacent to the rear wheels 16b as shown in FIG. 15.

Alternatively, and as shown in FIGS. 1 and 20, various audio speaker units 140 may be attached to the deck 12 so that the speaker unit 140 may emanate sound upward from the top of the deck 12 or from the lower end of the deck 12. The various audio speaker units 140 may be attached to the deck 12 in a manner in which a portion of the audio speaker unit 140 lies counter sunk and/or substantially with a surface of the deck 12.

Various brackets and/or connections may be provided and/or located anywhere throughout the deck 12 of the skateboard 10 to attach a replaceable self-contained modular unit 70. That is, the various replaceable self-contained modular units 70, 70a, 70b may be attached at various positions on the deck 12, including but not limited to the front, rear, top, bottom or along the sides of the deck 12.

As mentioned previously, the replaceable self-contained modular unit 70 may integrate a short-range wireless interconnection technology, such as a Bluetooth receiver. A stereo amplifier may be provide and adapted to receive wireless commands from a remote source, such as a mobile phone. The rider, or other individual within range, may pair their mobile device to the Bluetooth receiver in order to wirelessly connect/pair and establish remote control over the modular unit 70. An example would be using a music player embedded within the mobile device to control the speaker system of the audio source 30 and control the playback of music through the audio source 30.

The remote wireless transmitter, mobile device and/or music player may comprise any wireless and/or short-range wireless interconnection technology transmitted enabled music source, including but not limited to a phone, IPod, PDA or the like. Music may be played via any battery-operated device having a short-range wireless interconnection technology enabled device of any other person within range and traveling along with the skateboard 10 rider through the replaceable self-contained modular unit 70 attached to the skateboard 10. Conventional cellular technology can be implemented with the replaceable self-contained modular unit 70, such as GPS, near field communication and/or any other suitable wireless interconnection communication technology.

The skateboard 10 may also integrate a self generating current producing mechanism capable of providing power to the illumination source 30 and/or the audio source 40. For example, energy can be collected and recycled from the high speed rotation of the wheels of the skateboard. An example may include a construction where at least one induction coil assembly is integrated on at least one wheel assembly. At least one magnet containing wheel may be mounted on the wheel assembly about one side of an induction coil assembly and at least one light-emitting source or audio element source may be fixed to an outer periphery of the deck 12 of the skateboard 10. When wheels of the skateboard rotate at high speed, the magnets on the magnet containing wheels interact to cooperate with the induction coil assembly to produce current that drives the light-emitting source or audio element source to emit light and/or an audio sound.

According to this subject disclosure, the skateboard 10 may also provide a cradle into which a mobile phone, an audio player or other device may be docked and cradled. The cradle may be constructed to receive, support and protect the device in the cradle from hazardous impacts from the user atop the deck 12 of the skateboard 10, or from the extreme vibration jarring impacts by the uneven surfaces traversed by the user on the skateboard 10. The skateboarder may also incorporate the use of a holder to secure their mobile device in a manner so that remote control function can be performed in a convenient way and being easily accessible by the user. The holder may have a strap that can be secured to the wrist, arm, belt or any other suitable convenient location on the skateboarder or person traveling adjacent to the skateboarder.

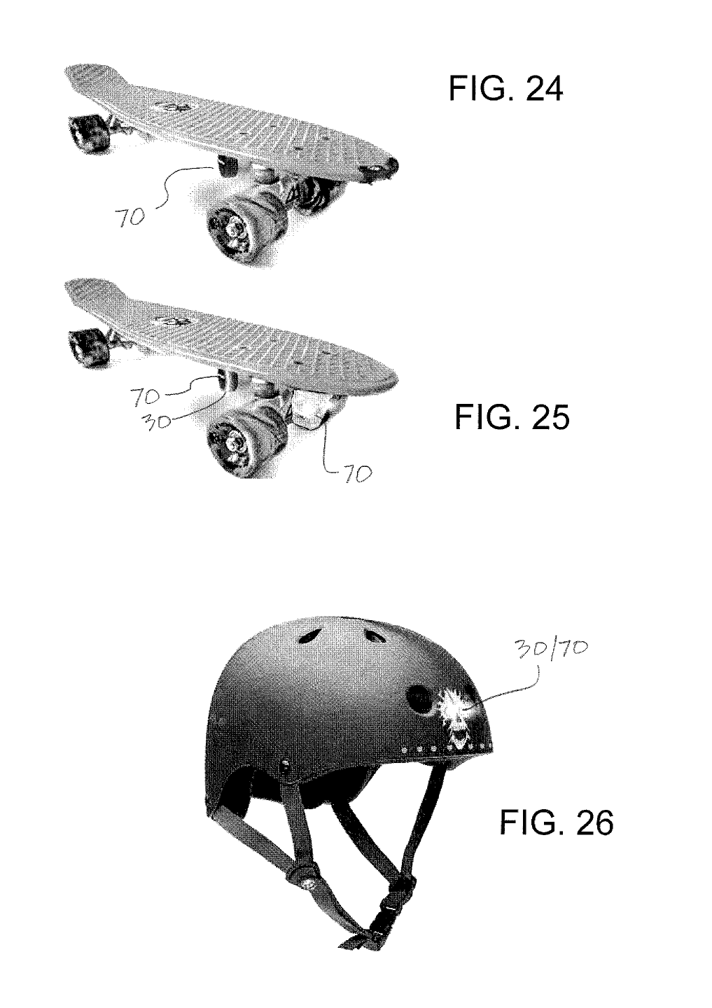

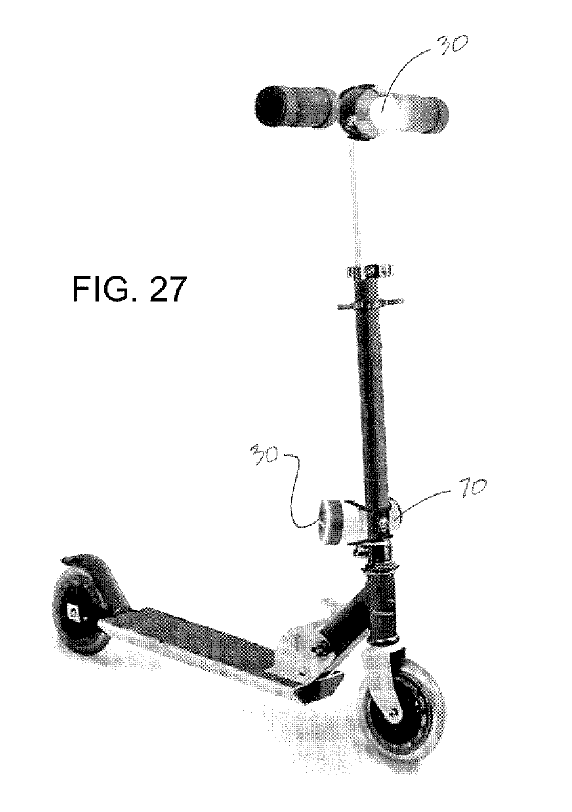

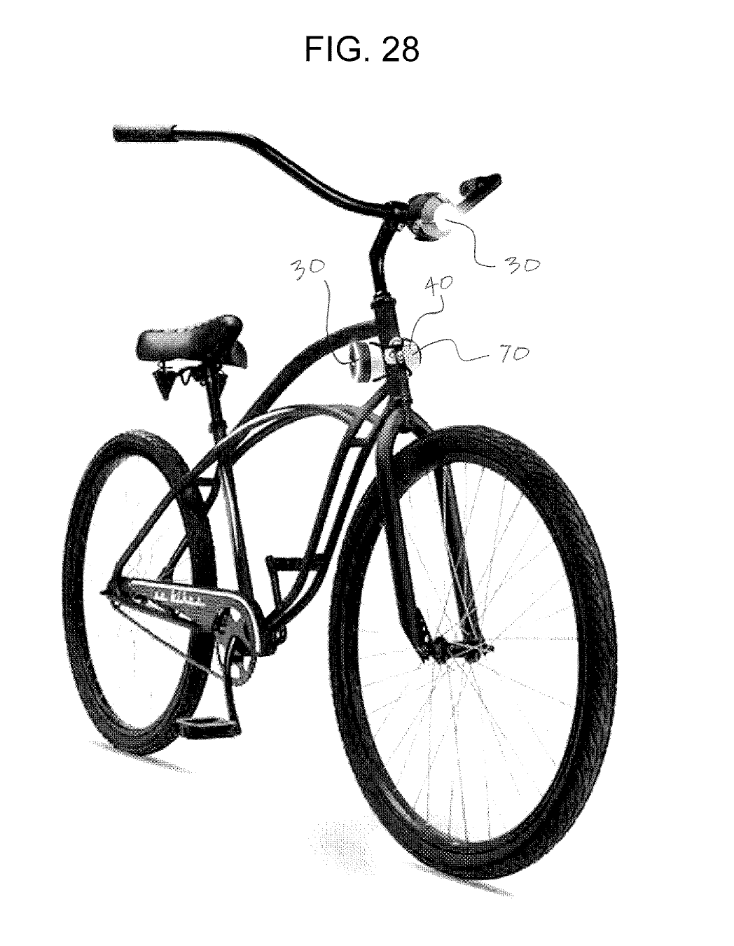

Various components of the skateboard 10, the replaceable self-contained modular unit 70 and other features of this subject disclosure may be used in combination with other sporting equipment such as bicycles, snowboards, skis, watercraft, surf boards, boogie boards, wake boards, skim boards, scooters, helmets, elbow and knee pads, gloves, wrist bands, head bands, shoes, glasses or the like (as shown in FIGS. 24-28). Likewise, these various items may be adapted to interact wirelessly with the ECU on the skateboard 10. For example, the helmet, glove, knee pads, elbow pads or the like may include various selectable elements and a wireless receiver that can wirelessly send and receive signaling instructions to and from the ECU in the skateboard 10 instructing various actionable features in the circuit 51 to take place, such as to turn on the light source 30 or turn on the audio or the like in response to buttons being pressed, or the helmet being turned as the wearer turns his head to make a turn. The movement can signal to the ECU 50 on the skateboard 10 to turn or off various lights 30 on the skateboard 10 according to various patterns dictated by the movement of the items worn by the skateboarder.

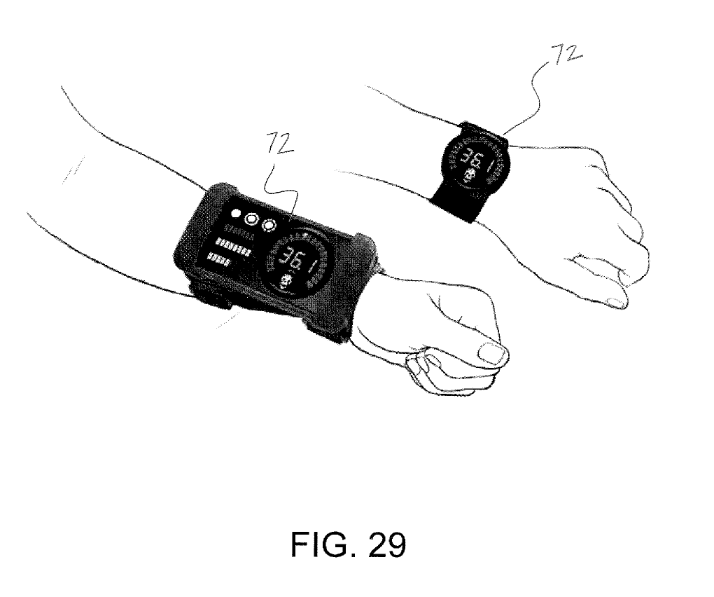

It is within this subject disclosure to contemplate that the various replaceable self-contained modular units 70 may be interchangeable and widely used between various diverse and different applications, for example, a skateboard, a bike, a snowboard, a scooter, a jet ski, rollerblades, etc. (as shown in FIGS. 24-28). As such, the replaceable self-contained modular units 70 may be used in broader technology markets without having to substantially create new or different tooling, packaging, etc. Alternatively, the replaceable self-contained modular unit 70 may be portably carried by the user and/or attached to a belt, a wrist strap (as shown in FIG. 29) or may be fastened to various other locations away from the transport device.

A mobile device application may be integrated with the features and functionality disclosed in this concept that allows users to communicate with each other and/or share videos and images amongst a pool of peers in a social media medium.

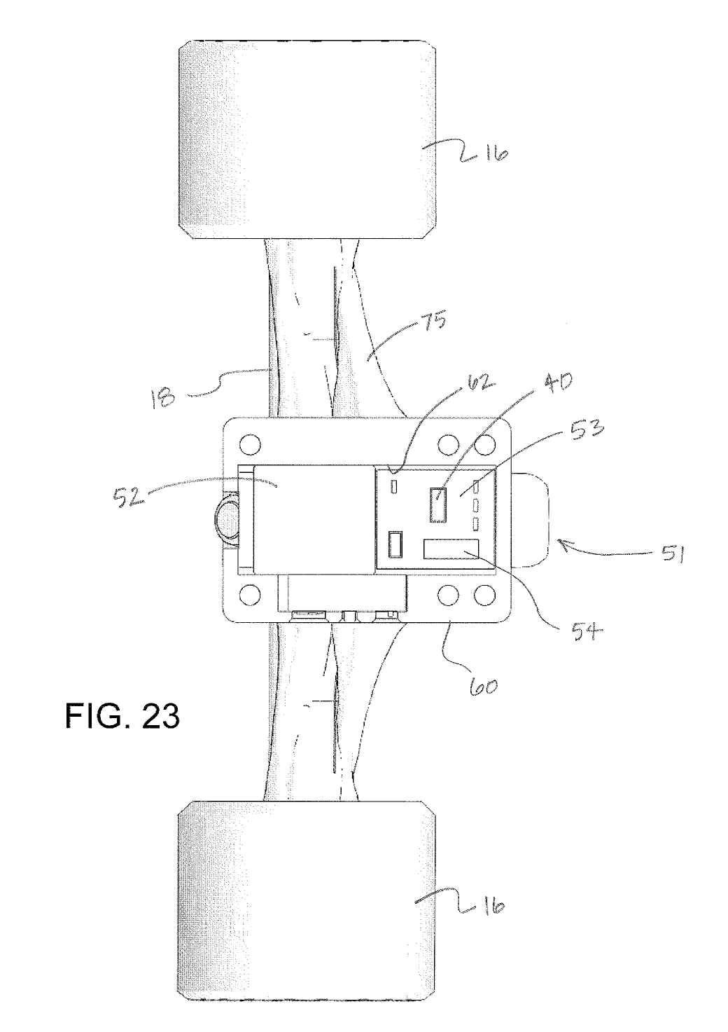

FIGS. 23-25 depict another embodiment in which the skateboard 10 includes a self contained truck assembly 60 having an internal self contained housing 62 into which at least a battery 52, an audio module 40 and a circuit 51 is all disposed and electronically connected on a circuit board 53. The circuit 51 may include a wireless transceiver 54 adapted to communicate signals wirelessly to and from the wireless transceiver 54 to a remote device. The wireless transceiver 54 may communicate with the remote device, such as a mobile phone, an iPod, a PDA and/or any other device capable of sending and receiving data information to and from the wireless transceiver 54 in the control circuit board 53. Signaling may take various forms and may include GPS, near field communication, RF and/or any other suitable wireless communication mode suitable for wireless communication.

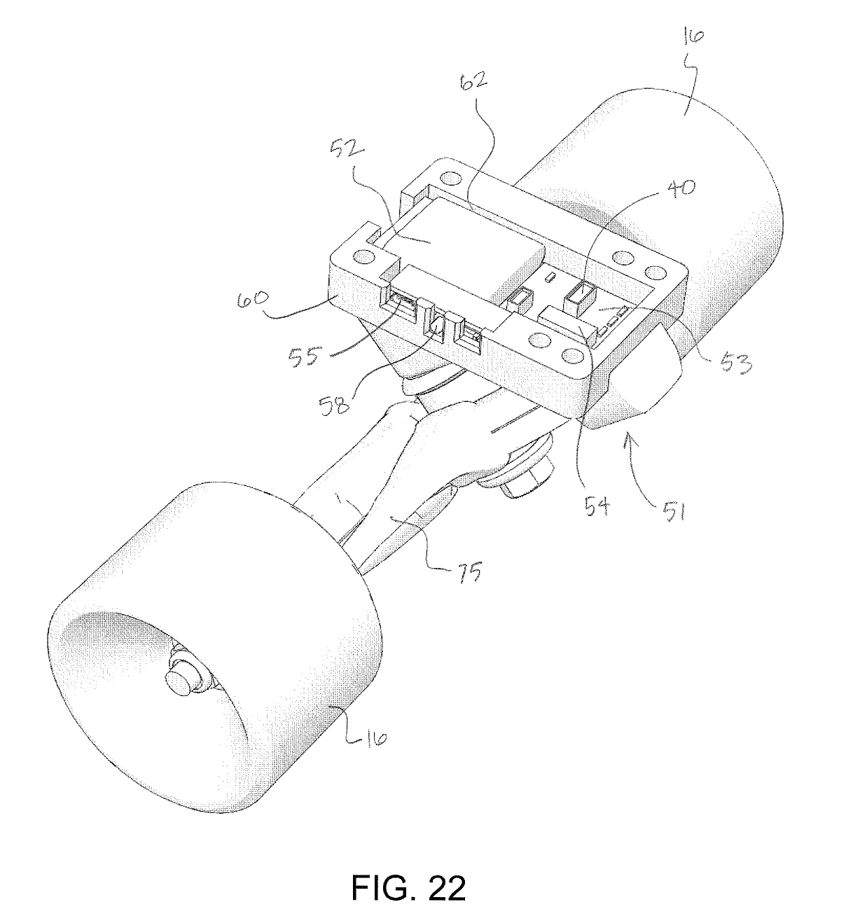

The self contained housing 62 is constructed completely within the upper end of the self contained truck assembly 60. That is, the self contained truck assembly 60 includes an internal chamber or housing 62 that receives and secures all of the electronic components of the control circuit 51. Various ports may be constructed to communicate with the circuit components housed within the internal chamber 62 within the self contained truck assembly 60. For example, a port 55 (as shown in FIG. 22), such as a USB charging cable port may be included in the housing 62 of the self contained truck assembly 60. A switch 58, such as a push button mode switch, a slide or other suitable switching mechanism may be integrated into the self contained truck assembly 60. The switch 58 may be provided to allow a user to switch among various modes. The various modes may include, but are not limited to: steady, flash, blinking, a particular color associated with the various modes and/or any other suitable mode according to this subject disclosure. An example of the various ports is depicted in FIG. 11.

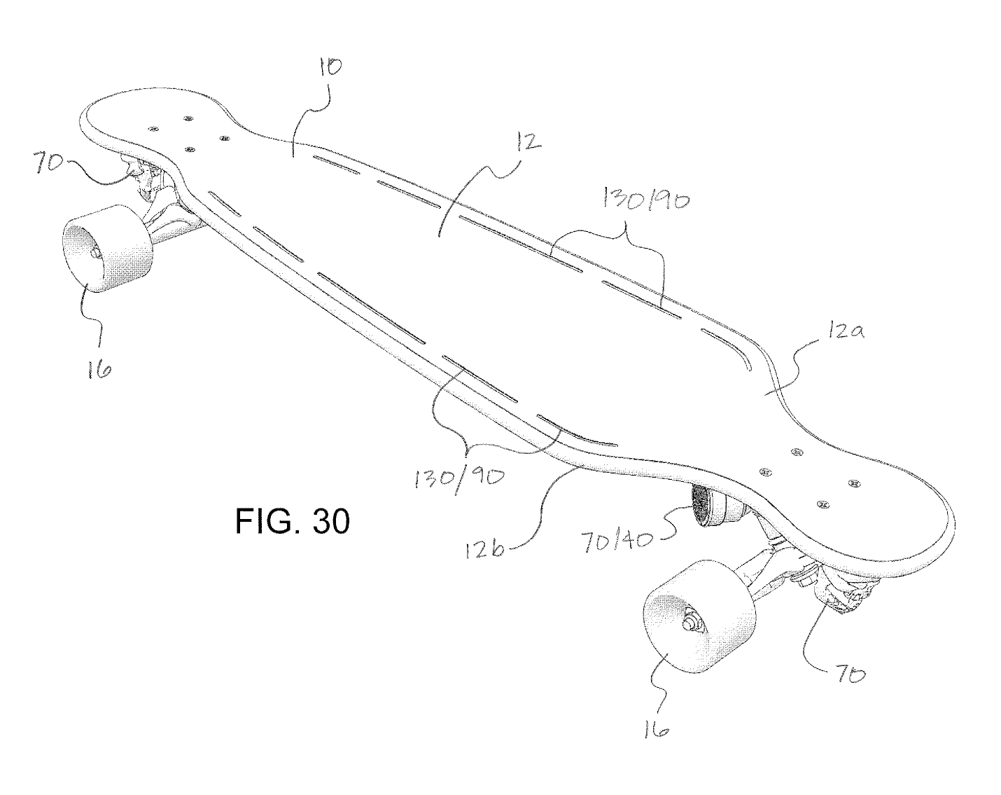

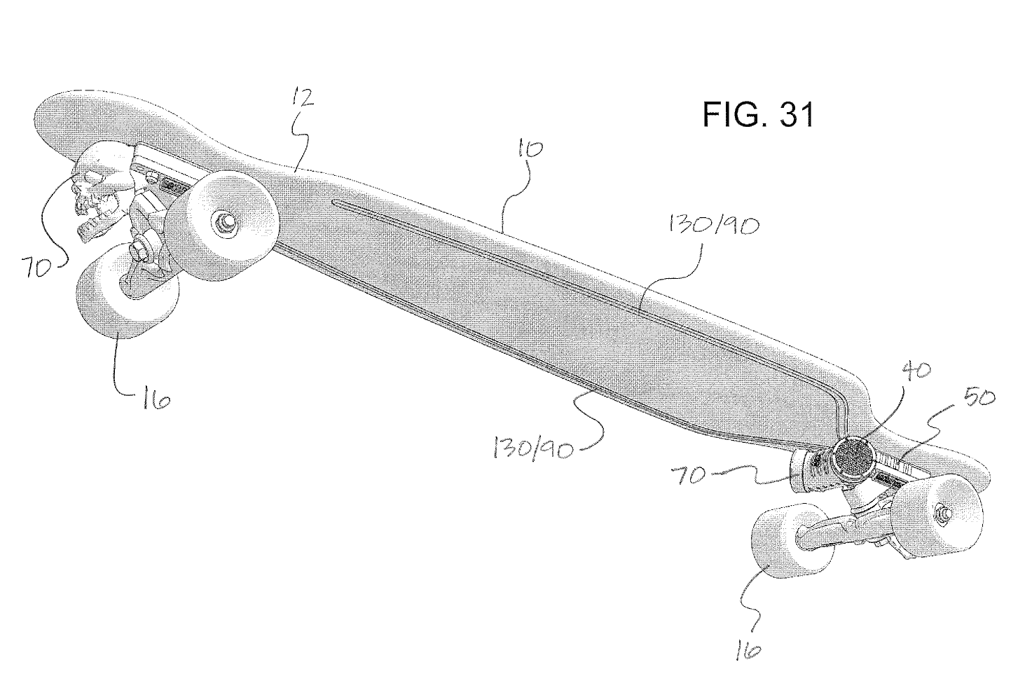

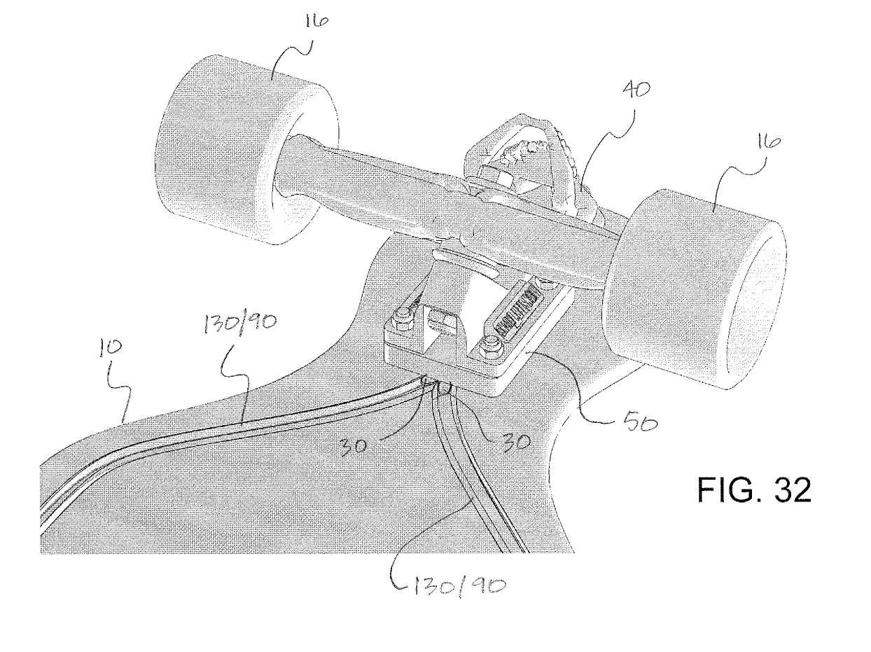

FIGS. 30-34 show various views of an illumination system connected to, and controlled by, the ECU in the skateboard 10. The skateboard deck 12 includes a plurality of channels 90 bored through the deck 12. Various illuminating strips 130 are disposed within the various channels 90 within the deck 12 that have been carved or routed out. The channels 90 extend through the deck 12 from an upper surface 12a to a lower surface 12b of the deck 12. The illuminating strips 130 can be made of any illuminating material capable of transmitting a light source through the illuminating strip 130. The illuminating strip 130 may be an electro-luminescent connected to the battery 52 power supply source embedded in the circuit 51.

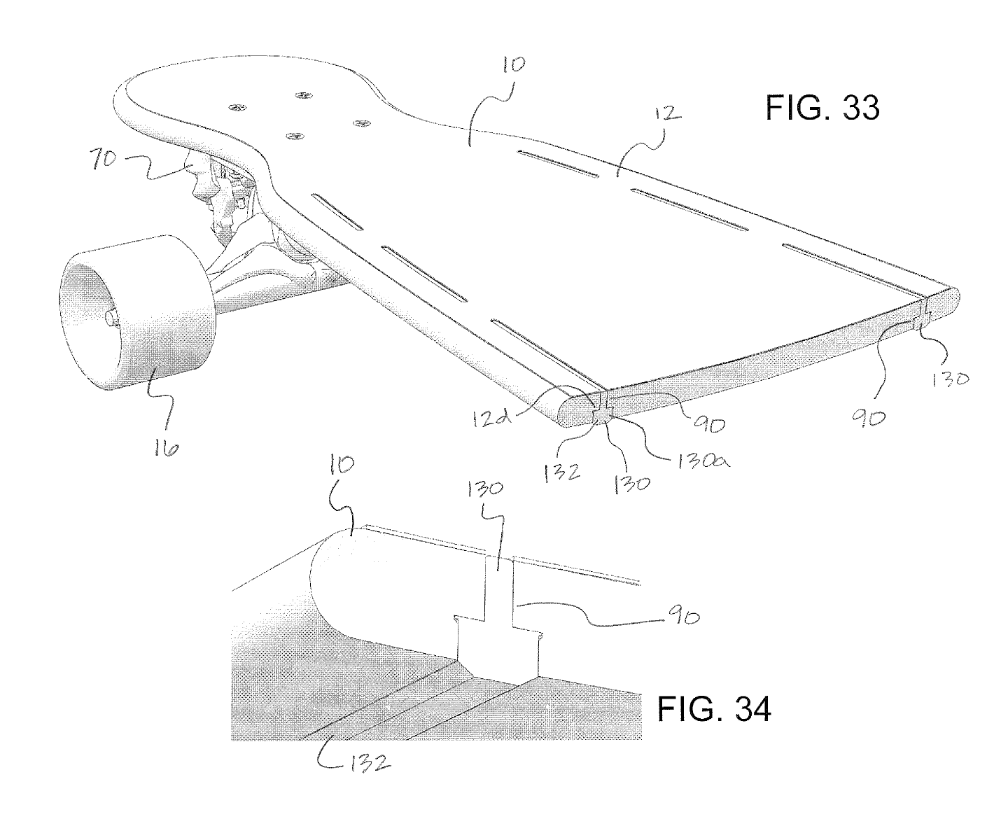

In FIGS. 33-34, the illuminating strip 130 is constructed to fit within channel 90 with a snap fit configuration. A pair of flanged shoulders 130a is constructed into a portion of the illuminating strip 130 in order to grab onto a mating ledge 12d within the deck 12 and prevent the illuminating strip 130 from being easily disconnected from within the channel 90. The illuminating strip 130 is constructed to have a lower portion 132 protruding through the bottom surface 12b of the deck 12 in order to allow the light emitted from the illuminating strip 130 to radiate radially downward and outward from the illuminating strip 130 to maximize the amount of light radiating below the skateboard 10 onto the road the skateboard 10 is traversing. The advantage of allowing the illuminating strip 130 to radiate through the top surface 12a of the deck 12 also serves to enhance the safety to the rider by illuminating the rider as he or she cruises on the skateboard 12 in the evening dark hours.

Although this invention has been disclosed and described in exemplary form with a certain degree of particularity, it is understood that the present disclosure of the exemplary form is only by way of example and that numerous changes in the details of operation and in the combination and arrangement of parts may be resorted to without departing from the spirit and scope of the invention as hereinafter claimed.

It will be recognized by those skilled in the art that changes or modifications may be made to the above described embodiments without departing from the broad inventive concepts of the invention. It is understood therefore that the invention is not limited to the particular embodiments which are described, but is intended to cover all modifications and changes within the scope and spirit of the invention.

What is claimed is:

1. A modular unit for a transport device comprising:
an anchor unit connected to the transport device; and
a housing having a fastening mechanism adapted to releasably quick connect and remove the housing to and from the anchor unit, the housing comprising:
an electronic control unit (ECU) electrically connected within a control circuit.

2. The modular unit recited in claim 1, wherein the anchor unit is connected to at least one of a transport device for use on land, in air or in water.

3. The modular unit recited in claim 1, wherein the housing comprises:
an illumination source; and
an audio source.

4. The modular unit recited in claim 1, wherein the ECU is electrically connected to control at least one of the illumination source or the audio source.

5. The modular unit recited in claim 1, wherein the housing further comprises:
a wireless communication transceiver adapted to send and receive wireless signals to and from a remote wireless device to the ECU to control at least one of the illumination source and the audio source.

6. The modular unit recited in claim 1, wherein the fastening mechanism includes a male connection and a female connection that releasably interlocks with each other in a quick disconnect manner.

7. The modular unit recited in claim 6, wherein one of the anchor plate and the housing comprises the male connection and the other includes the female connection.

8. The modular unit recited in claim 6, wherein the male connection is a projection and the female connection is a groove that snap locks onto the male connection.

9. The modular unit recited in claim 1, wherein at least one or both of the illumination source or the audio source includes an illumination transmission routine pattern or an audio transmission routine pattern controlled by the electronic control unit (ECU).

10. A modular unit for a skateboard comprising:
an anchor plate fastened to trucks of the skateboard; and
a housing having a fastening mechanism adapted to releasably connect to the anchor plate, the housing comprising:
an illumination source; and
an electronic control unit (ECU) electrically connected to control the illumination source.

11. The modular unit recited in claim 10, wherein the housing further comprises:
an audio source having a speaker electrically connected to the ECU that controls the audio source.

12. The modular unit recited in claim 11, wherein the housing further comprises:
a wireless communication transceiver adapted to send and receive wireless signals to and from a remote device to the ECU to control the illumination source and the audio source.

13. The modular unit recited in claim 12, wherein at least one or both of the illumination source or the audio source includes an illumination transmission routine pattern or an audio transmission routine pattern controlled by the electronic control unit (ECU).

14. The modular unit recited in claim 10, wherein the fastening mechanism includes a male connection and a female connection that releasably interlock with each other in a quick disconnect manner.

15. The modular unit recited in claim 10, wherein one of the anchor unit and the interchangeable housing comprises the male connection having a projection and the other includes the female connection having a slot, wherein the projection snap slides into the slot and locks onto the projection.

16. A modular unit for a transport device comprising:
an anchor unit connected to the transport device; and
an interchangeable housing having a quick disconnect fastening mechanism adapted to releasably connect to and from the anchor unit, wherein the interchangeable housing further comprises:
an audio source having a speaker; and
an electronic control unit (ECU) electrically connected to the audio source.

17. The modular unit recited in claim 16, wherein the interchangeable housing further comprises:
an illumination source electrically connected to the ECU to control the illumination source.

18. The modular unit recited in claim 17, wherein the interchangeable housing further comprises:
a wireless communication transceiver adapted to send and receive wireless signals to and from a remote device to the ECU to control at least one of the audio source or the illumination source.

19. The modular unit recited in claim 16, wherein the quick disconnect fastening mechanism includes a male connection and a female connection that releasably interlocks the male connection with the female connection.

20. The modular unit recited in claim 19, wherein one of the anchor unit and the interchangeable housing comprises the male connection having a projection and the other includes the female connection having a slot, wherein the projection snap slides into the slot and locks onto the projection.
